(19) United States
(12) Patent Application Publication
(10) Pub. No.: US 2009/0004421 A1
(43) Pub. Date: Jan. 1, 2009

(54) Adhesive Chopping Board

(76) Inventor: Hyuk Youn, Seoul (KR)

Correspondence Address: John W. Renner;Renner, Otto, Boisselle & Sklar, 1621 Euclid Avenue, 19th Floor, Cleveland, OH, 44115, US

(21) Appl. No.: 12/087,565

(22) PCT Filed: Jan. 17, 2007
(86) PCT No.: PCT/KR2007/000279

§ 371 Date: Jul. 7, 2008

(30) Foreign Application Priority Data
Jan. 19, 2006 (KR) 20-2006-0001660

(51) Int. Cl. B32B 7/06

(52) U.S. Cl. 428/41.7; 428/353; 428/337

(57) ABSTRACT

Disclosed is an adhesive chopping board. The adhesive chopping board includes a main body (1); a primer layer coated on (2) the entire lower surface or a portion of the lower surface of the main body (1); and a pressure sensitive adhesive layer (3) applied to the lower surface of the primer layer (2) corresponding to the region of the lower surface of the main body (1) coated with the primer layer (2) so that the chopping board is re-attachable. The adhesive chopping board is fixed to a floor so as to efficiently cut foodstuffs laid thereon, and is easily separated from the floor and kept when the chopping board is not used.

### TECHNICAL FIELD

The present invention relates to a chopping board, and more particularly to a functional chopping board, in which an adhesive layer is detachably applied to the lower surface of a main body so that the chopping board is stably fixed to a floor by the adhesive power of the adhesive layer, and the main body has a small thickness so that the chopping board is conveniently carried and kept.

### BACKGROUND ART

In order to cook food in most homes and restaurants, a general chopping board 1′, as shown in FIG. 1, is used. Such a chopping board 1′ is made of polyethylene, polypropylene, or wood. However, since the above conventional chopping board is not completely fixed to a floor, the chopping board 1′ moves when foodstuffs are cut on the chopping board, thus being incapable of efficiently cutting the foodstuffs.

In order to solve the above problem, various chopping boards have been developed. For example, a chopping board has an increased thickness and thus has an increased weight, thereby not moving when it is used to cut foodstuffs laid thereon. Further, another chopping board is provided with a skid-proof agent coated on the lower surface thereof, thus not moving when it is used to cut foodstuffs laid thereon.

However, the above chopping boards are disadvantageous in that the overall sizes or weights thereof are increased.

Accordingly, the chopping boards are not easily kept and carried, and have high production costs.

### TECHNICAL PROBLEM

Therefore, the present invention has been made in view of the above problems, and it is an object of the present invention to provide an adhesive chopping board, which has minimized size and volume, and does not move when the chopping board is used to cut foodstuffs laid thereon.

### TECHNICAL SOLUTION

In accordance with an aspect of the present invention, the above and other objects can be accomplished by the provision of an adhesive chopping board comprising a main body; a primer layer coated on the entire lower surface or a portion of the lower surface of the main body; and a pressure sensitive adhesive layer applied to the lower surface of the primer layer corresponding to the region of the lower surface of the main body coated with the primer layer so that the chopping board is re-attachable.

Preferably, the adhesive chopping board further comprises a covering paper, for protecting the pressure sensitive adhesive layer, which has a size corresponding to the size of the pressure sensitive adhesive layer on the lower surface of the main body and is attached to the main body such that one surface of the covering paper coated with silicon resin contacts the pressure sensitive adhesive layer.

Further, preferably, the main body has a thickness of 5 mm or less.

### ADVANTAGEOUS EFFECTS

The adhesive chopping board of the present invention has several effects, as follows.

First, the adhesive chopping board of the present invention has reduced volume and size, thus being easily carried and kept.

Second, the adhesive chopping board of the present invention is completely fixed to a floor when the chopping board is used to cut foodstuffs laid thereon, and prevents accidents caused by the movement of the chopping board, thus allowing a user to safely cut the foodstuffs.

Third, the adhesive chopping board of the present invention is easily separated from the floor after use, and does not leave any trace on the floor, thus being conveniently and cleanly used.

### DESCRIPTION OF DRAWINGS

The above and other objects, features and other advantages of the present invention will be more clearly understood from the following detailed description taken in conjunction with the accompanying drawings, in which:

FIG. 1 is a schematic perspective view of a general chopping board;

FIG. 2 is a schematic view illustrating an adhesive chopping board in accordance with the present invention, in which the lower surface of a main body is coated with a primer layer and a pressure sensitive adhesive layer, and a covering paper attached to the main body;

FIG. 3 is a schematic view illustrating the adhesive chopping board in accordance with the present invention, in a usable state after the covering paper is separated from the main body; and

FIG. 4 is a schematic view illustrating the adhesive chopping board in accordance with the present invention, in a state in which the chopping board is attached to a floor after the covering paper is separated from the main body.

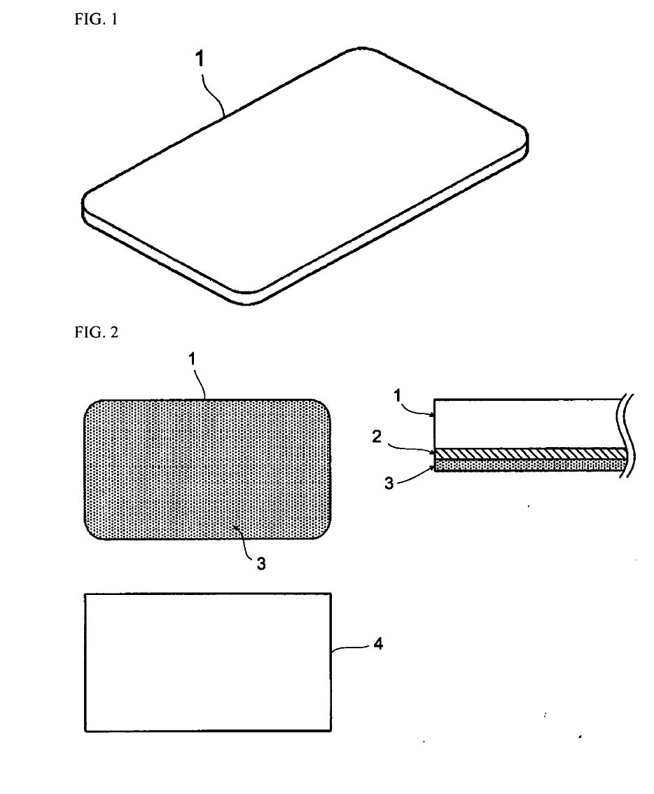

### BEST MODE

Now, a preferred embodiment of the present invention will be described in detail with reference to the annexed drawings. The present invention is not limited to the embodiment, which will be disclosed later, but various modifications, additions and substitutions of the embodiment are possible, without departing from the scope and spirit of the invention as disclosed in the accompanying claims. The preferred embodiment of the present invention has been disclosed for illustrative purposes to those skilled in the art.

Generally, in order to achieve a re-attachable purpose of re-attachable notes, such as Post-it notes, a pressure sensitive adhesive having designated constituents is used. However, in order to increase the efficiency of the re-attachable notes, a primer and a pressure sensitive adhesive are used together. In consideration of the above respect, a chopping board of the present invention includes a pressure sensitive adhesive layer and a primer layer.

FIG. 2 is a schematic view illustrating an adhesive chopping board in accordance with the present invention, in which the lower surface of a main body is coated with a primer layer and a pressure sensitive adhesive layer, and a covering paper attached to the main body. The main body 1 is made of synthetic resin, such as polyethylene or polypropylene, or wood. Preferably, in order to easily carry and keep the chopping board, the main body 1 has a thickness of 5 mm or less. Further, preferably, when the main body 1 has the above thickness, the main body 1 is made of synthetic resin rather than wood so as to secure the solidity of the adhesive chopping board.

Here, the covering paper 4 means a release paper. In order to protect an adhesive surface of the chopping board when the chopping board is delivered from a warehouse, the covering paper 4 is attached to the adhesive surface of the chopping board.

As described above, the adhesive chopping board includes the primer layer 2 and the pressure sensitive adhesive layer 3, which are coated on the lower surface of the main body 1, so that the chopping board is re-attachable. The primer layer 2 and the pressure sensitive adhesive layer 3 may have thicknesses enough to secure the fixing power of the chopping board. That is, the primer layer 2 and the pressure sensitive adhesive layer 3 have small thicknesses so that they are easily indistinguishable from each other apparently.

Preferably, the primer layer 2 and the pressure sensitive adhesive layer 3 are applied to the entire lower surface of the main body 1. However, in order to reduce the production cost of the chopping board and meet the convenience in use of the chopping board, the primer layer 2 and the pressure sensitive layer 3 may be applied only to a portion of the lower surface of the main body 1. Preferably, in this case, when the chopping board has a rectangular shape, the primer layer 2 and the pressure sensitive adhesive layer 3 are applied to corners or edges of the lower surface of the main body 1 such that the primer layer 2 and the pressure sensitive adhesive layer 3 have a designated width, so as to sufficiently fix the chopping board to a floor.

The primer serves to firmly attach the pressure sensitive adhesive to the main body 1, and thus to prevent the pressure sensitive adhesive from transferring from the main body 1 to an object, to which the chopping board is attached. The primer is coated on the lower surface of the main body 1, thus forming the primer layer 2. Then, the pressure sensitive adhesive is coated on the primer layer 2, thus forming the pressure sensitive adhesive layer 3. The primer used in the primer layer 3 includes a polymer resin, which can be formed in a film shape, such as acrylic resin, urethane resin or vinyl resin, and, as circumstances require, may further include inorganic matters, such as titanium oxide, magnesium oxide, zinc oxide, barium sulfate, calcium carbonate, clay, zeolite, alumina, silica, and so on. The primer is not limited to specific constituents. In order to meet the object of the chopping board in that the fixed position of the chopping board on the floor is easily changed, the pressure sensitive adhesive used in the pressure sensitive adhesive layer 3 must have an adhesive property, which is scarcely changed even if the attachment and detachment of pressure sensitive adhesive layer 3 to and from an object is repeated. The pressure sensitive adhesive used in the chopping board may be a pressure sensitive adhesive, which is mainly used in re-attachable notes, (for example, Post-it notes; Trademark of 3M).

Accordingly, in the same manner as the general pressure sensitive adhesive, the pressure sensitive adhesive used in the pressure sensitive adhesive layer 3 includes a mixture of natural and synthetic rubbers and a tackifier, or acrylic resin, and preferably includes acrylic resin. The acrylic resin is synthesized by emulsion polymerization, solution polymerization, or suspension polymerization. More preferably, the pressure sensitive adhesive includes acrylic resin having a spherical shape synthesized by suspension polymerization in view of the fact that the adhesive chopping board has a low adhesive strength and is repeatedly used. If necessary, the pressure sensitive adhesive may include a mixture of acrylic resin synthesized by suspension polymerization, and acrylic resin synthesized by emulsion polymerization or acrylic resin synthesized by solution polymerization. The pressure sensitive adhesive of the chopping board of the present invention has a re-attachable property, and is not limited to specific constituents.

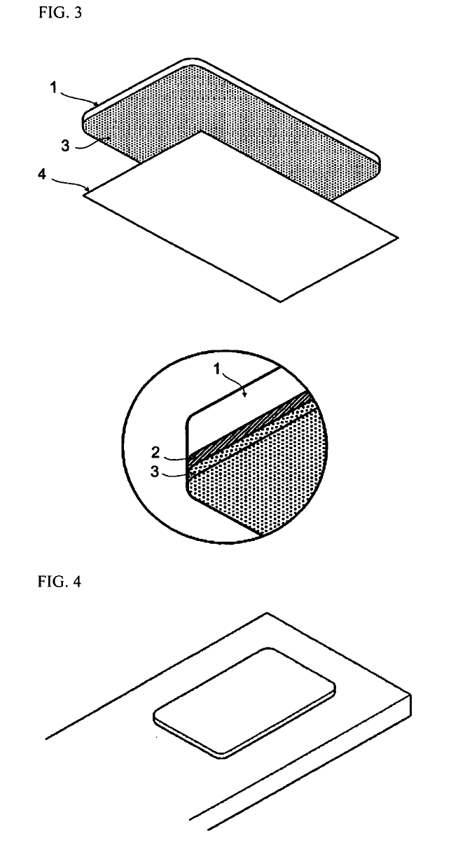

As shown in FIG. 3, preferably, the adhesive chopping board further includes the covering paper provided with one surface, which is coated with silicon resin and is attached to the surface of the main body 1 coated with the pressure sensitive adhesive layer 3 so as to protect the adhesive surface of the adhesive chopping board. FIG. 3 illustrates the adhesive chopping board in a usable state after the covering paper 4 is separated from the main body 1.

FIG. 4 illustrates the adhesive chopping board in a state in which the surface of the chopping board provided with the pressure sensitive adhesive layer is attached to a floor after the covering paper 4 is separated from the main body 1. When the chopping board is used to cut foodstuffs laid thereon, after the covering paper 4 is removed from the main body 1 and the surface of the main body 1 provided with the pressure sensitive adhesive layer 3 is attached to the floor, the foodstuffs are put on the upper surface of the main body 1.

In order to protect the adhesive lower surface of the chopping board provided with the pressure sensitive adhesive layer 3, the covering paper 4 having a size corresponding to the adhesive lower surface of the chopping board is preferably attached to the main body 1.

The surface of the covering paper 4 contacting the adhesive lower surface of the chopping board is coated with silicon resin. Preferably, in order to completely protect the adhesive lower surface of the chopping board, the silicon resin is coated on the entire surface of the covering paper 4 contacting the adhesive lower surface of the chopping board.

When the surface of the covering paper 4 coated with the silicon resin correspondingly contacts the adhesive lower surface of the chopping board provided with the pressure sensitive adhesive layer 3, the covering paper 4 can protect the adhesive lower surface of the chopping board. The covering paper 4 serves to protect the adhesive lower surface of the chopping board before the chopping board is used. Once the covering paper 4 is removed from the chopping board, the covering paper 4 can be continuously attached to and detached from the chopping board.

### INDUSTRIAL APPLICABILITY

As apparent from the above description, the present invention provides an adhesive chopping board, which has several effects, as follows.

First, the adhesive chopping board of the present invention has reduced volume and size, thus being easily carried and kept.

Second, the adhesive chopping board of the present invention is completely fixed to a floor when the chopping board is used to cut foodstuffs laid thereon, and prevents accidents caused by the movement of the chopping board, thus allowing a user to safely cut the foodstuffs.

Third, the adhesive chopping board of the present invention is easily separated from the floor after use, and does not leave any trace on the floor, thus being conveniently and cleanly used.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. An adhesive chopping board comprising:
a main body;
a primer layer coated on the entire lower surface or a portion of the lower surface of the main body; and
a pressure sensitive adhesive layer applied to the lower surface of the primer layer corresponding to the region of the lower surface of the main body coated with the primer layer so that the chopping board is re-attachable.

2. The adhesive chopping board according to claim 1, further comprising a covering paper, for protecting the pressure sensitive adhesive layer, which has a size corresponding to the size of the pressure sensitive adhesive layer on the lower surface of the main body and is attached to the main body such that one surface of the covering paper coated with silicon resin contacts the pressure sensitive adhesive layer.

3. The adhesive chopping board according to claim 1, wherein the main body has a thickness of 5 mm or less.

4. The adhesive chopping board according to claim 2 wherein the main body has a thickness of 5 mm or less.
